(19) United States
(12) Patent Application Publication
(10) Pub. No.: US 2012/0105601 A1
(43) Pub. Date: May 3, 2012

(54) Apparatus and method for creating three-dimensional panoramic image by using single camera

(75) Inventors: Young Sun Jeon, Yongin-si (KR); Young Su Moon, Seoul (KR); Shi Hwa Lee, Seoul (KR)

(73) Assignee: SAMSUNG ELECTRONICS CO., LTD., Suwon-si (KR)

(21) Appl. No.: 13/067,449

(22) Filed: Jun. 1, 2011

(30) Foreign Application Priority Data
Oct. 27, 2010 (KR) 10-2010-0105124

(51) Int. Cl. H04N 13/02

(52) U.S. Cl. 348/50; 348/E13.074

(57) ABSTRACT

An apparatus and method for creating a three-dimensional (3D) panoramic image using a single camera are provided. The method includes capturing an object from a plurality of viewpoints, determining at least one capture viewpoint from which an image is obtained by capturing the object, among the plurality of viewpoints, collecting at least one image of the captured object from the at least one capture viewpoint, and creating a 3D image from the collected at least one image.

### CROSS-REFERENCE TO RELATED APPLICATIONS

This application claims the priority benefit of Korean Patent Application No. 10-2010-0105124, filed on Oct. 27, 2010, in the Korean Intellectual Property Office, the disclosure of which is incorporated herein by reference.

### BACKGROUND

1. Field

Embodiments of the following description relate to an apparatus and method for creating a three-dimensional (3D) panoramic image using a single camera, and more particularly, provide a technical aspect to create a 3D panoramic image using an existing two-dimensional (2D) camera, without a change in hardware for 3D capturing such as 3D lenses or a stereoscopic system.

2. Description of the Related Art

Due to rapid development of digital technologies, demands for a three-dimensional (3D) display such as a 3D Television (TV) continue to increase.

A 3D display may be provided through 3D image content, and the 3D image content may appear as if an object is in 3D space.

To create a 3D image content, a scheme of reproducing a 3D image has been actually tried. However, a technology of providing a left eye and right eye with a same image as images viewed from a left direction and a right direction, of providing viewpoints to the left and right eyes, and combining the viewpoints to show a single a 3D image is being widespread.

A 3D image content may be created from a two-dimensional (2D) image by applying two eyes and a stereoscopic technology. Additionally, to create a 3D image content, images captured using at least two cameras are generally demanded.

Specifically, the stereoscopic technology may create information to be additionally obtained from a 2D image, and may enable a user to feel lifelike and realistic as if the user is in a location where an image is formed, due to the created information.

### SUMMARY

According to an aspect of one or more embodiments, there is provided a portable terminal device including a capturing unit to capture an object from a plurality of viewpoints, an image capture determination unit to determine at least one capture viewpoint from which an image is obtained by capturing the object, among the plurality of viewpoints, an image collection unit to collect at least one image of the captured object from the at least one capture viewpoint, and a three-dimensional (3D) image creation unit to create a 3D image from the collected at least one image.

According to an aspect of one or more embodiments, there is provided a 3D image generation method of a portable terminal device, including capturing an object from a plurality of viewpoints, determining at least one capture viewpoint from which an image is obtained by capturing the object, among the plurality of viewpoints, collecting at least one image of the captured object from the at least one capture viewpoint, and creating a 3D image from the collected at least one image, wherein the plurality of viewpoints are classified based on a rotation in a fixed location.

According to an aspect of one or more embodiments, there is provided a portable terminal device including an image capture determination unit to determine at least one capture viewpoint from which an image is obtained by capturing an object from a plurality of viewpoints; an image collection unit to collect at least one image of the captured object from the at least one capture viewpoint; and a three-dimensional (3D) image creation unit to create a 3D image from the collected at least one image using at least one processor.

According to an aspect of one or more embodiments, there is provided a 3D image generation method of a portable terminal device including determining at least one capture viewpoint from which an image is obtained by capturing an object from a plurality of viewpoints; collecting at least one image of the captured object from the at least one capture viewpoint; and creating a 3D image from the at least one collected image using at least one processor, wherein the plurality of viewpoints are classified based on a rotation in a fixed location.

According to an aspect of one or more embodiments, there is provided a portable terminal fro generating a three dimensional image including a capturing unit which captures the object from the plurality of viewpoints generated by a rotation in a fixed location; an image capture determination unit, using at least one processor, to determine at least one capture viewpoint, which is classified as a rotation angle of a selected size, by determining the selected size of the rotation angle so that images of the object captured from consecutive capture viewpoints are superimposed on at least one predetermined area; and an image collection unit to collect at least one image of the captured object from the at least one capture viewpoint for generation of the 3D image.

According to another aspect of one or more embodiments, there is provided at least one non-transitory computer readable medium storing computer readable instructions to implement methods of one or more embodiments.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a diagram of an example of capturing an object from a plurality of viewpoints according to one or more embodiments;

FIG. 2 illustrates a diagram of an example of projecting a captured image of FIG. 1 using a spherical coordinate system or a cylindrical coordinate system according to one or more embodiments;

FIG. 3 illustrates a block diagram of a portable terminal device according to one or more embodiments;

FIG. 4 illustrates a diagram of capture viewpoints captured from a plurality of viewpoints according to one or more embodiments; and

FIG. 5 illustrates a flowchart of a three-dimensional (3D) image generation method of a portable terminal device according to one or more embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

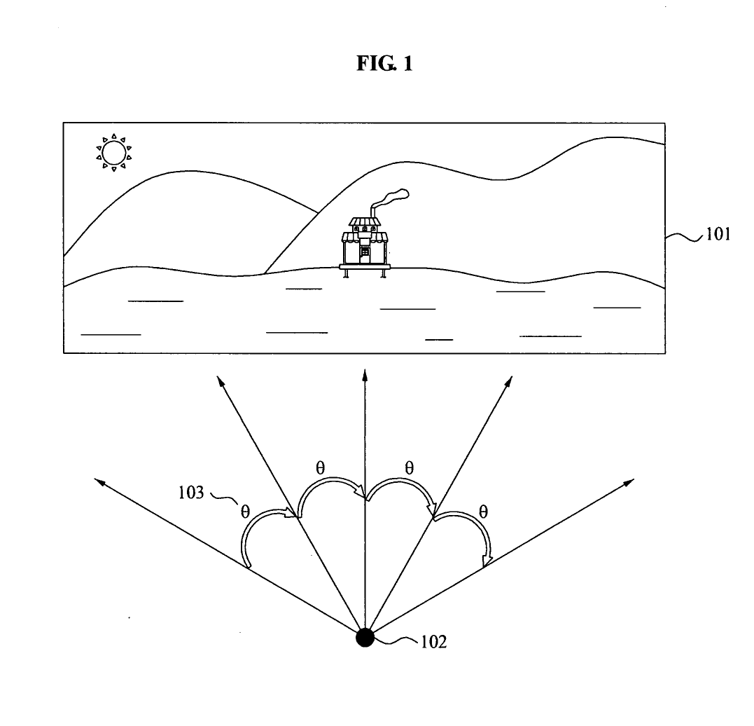

FIG. 1 illustrates a diagram of an example of capturing an object from a plurality of viewpoints according to one or more embodiments.

A portable terminal device according to one or more embodiments may create a three-dimensional (3D) image using a camera 102 that captures an object 101 from a plurality of viewpoints. Examples of a portable terminal device include a mobile phone, a personal digital assistant, a portable media player, a laptop, and a tablet.

The camera 102 may be rotated in a fixed location, and may create a plurality of images for the object 101 that are partially superimposed.

In other words, the camera 102 may capture the object 101 from the plurality of viewpoints generated by a rotation of the camera 102 in the fixed location.

Here, the camera 102 may be rotated based on a movement of a user, instead of being rotated by predetermined hardware for moving the camera 102.

Accordingly, there is no need to add hardware for rotating the camera 102.

Images created by capturing the object 101 from predetermined viewpoints, namely capture viewpoints, during the rotation of the camera 102, may be processed into a 3D image.

Consecutive capture viewpoints among a plurality of capture viewpoints may be generated by rotating the camera 102 by an angle ‘θ’. Here, a portion of images captured from the consecutive capture viewpoints may be superimposed.

The portable terminal device may determine, as a capture viewpoint, a viewpoint generated by rotating the camera 102 by an angle ‘θ’ 103, and may control the control 102 to capture the object 101.

Capture viewpoints may be classified as a rotation angle ‘θ’ of a selected size.

Specifically, to process images captured from different capture viewpoints for each angle ‘θ’ into a 3D image, the images may be classified into left images and right images.

For example, when a first image, a second image, a third image, and a fourth image are sequentially captured, the portable terminal device may determine the first image as a left image, and may determine the second image as a right image, to process a first 3D image. Additionally, the portable terminal device may determine the third image as a left image, and may determine the fourth image as a right image, to process a second 3D image.

The created first 3D image and the created second 3D image may be processed into a 3D panoramic image.

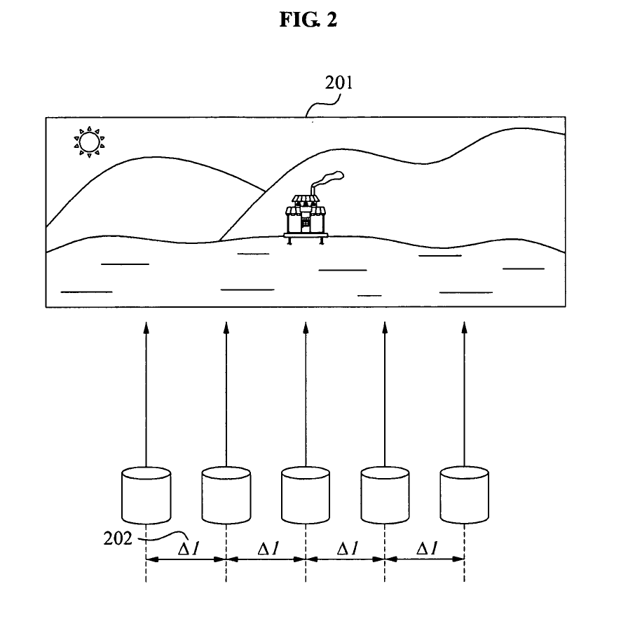

FIG. 2 illustrates a diagram of an example of projecting a captured image of FIG. 1 using a spherical coordinate system or a cylindrical coordinate system. The image captured by rotating the camera 102 by a predetermined angle based on the fixed location as illustrating in FIG. 1, may be represented as an image captured by translating and moving the camera 102 in regular intervals in the spherical coordinate system as illustrated in FIG. 2.

In other words, images captured from the plurality of capture viewpoints by the rotation of the camera 102 may be determined to be identical to images captured by a horizontal movement of the camera 102, due to a minor difference between the images captured by the rotation of the camera 102 and the images captured by the horizontal movement of the camera 102.

Referring to FIG. 2, the camera 102 may recognize a viewpoint 202 generated by moving the camera 102 by ‘Δ/’ as a capture viewpoint, and may capture an object 201. Images of the object 201 captured by the camera 102 may be almost identical to each other, except for a portion of edges of the images.

Accordingly, the portable terminal device may create a 3D panoramic image using only the camera 120, by merely rotating the camera 102, without moving a location of the camera 102, as illustrated in FIG. 1.

Thus, according to one or more embodiments, it is possible to create a 3D panoramic image using only a single camera. Additionally, existing portable terminal devices may be compatible, without a change in hardware.

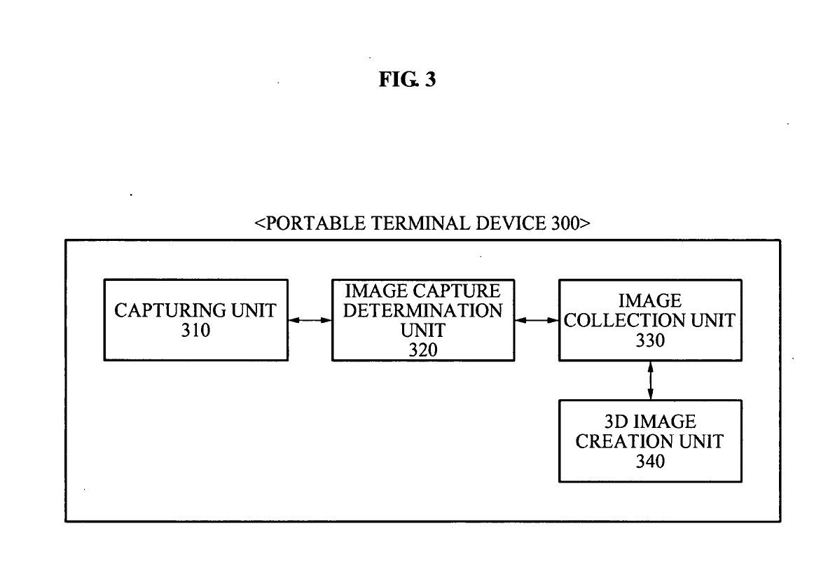

FIG. 3 illustrates a block diagram of a portable terminal device 300 according to one or more embodiments. Examples of a portable terminal device 300 include a mobile phone, a personal digital assistant, a portable media player, a laptop, and a tablet.

The portable terminal device 300 of FIG. 3 may determine a plurality of capture viewpoints with respect to an object, and may create at least one 3D image using a plurality of captured images that are respectively captured from the plurality of capture viewpoints.

The portable terminal device 300 may determine a capture viewpoint used to capture and create an actual image for the object, among the plurality of capture viewpoints.

A camera may capture images of the object from various capture viewpoints, based on capture viewpoints determined by the portable terminal device 300.

Here, the portion of the captured images may be determined as left images, and the other portion may be determined as right images. The left images and right images may be combined to create a 3D image.

Accordingly, the portable terminal device 300 may include a capturing unit 310, an image capture determination unit 320, an image collection unit 330, and a 3D image creation unit 340, as illustrated in FIG. 3.

The capturing unit 310 may capture an object from a plurality of viewpoints, and may include, for example, a single camera.

The capture unit 310 may capture the object from various viewpoints generated when the camera is rotated by a user.

The image capture determination unit 320 may determine at least one capture viewpoint from which an image is obtained by capturing the object, among the plurality of viewpoints.

For example, the image capture determination unit 320 may determine a size of a rotation angle so that images of the object captured from consecutive capture viewpoints may be superimposed on at least one predetermined area.

Here, the capture viewpoints may be used to capture actual images that form a 3D image or a 3D panoramic image. The image capture determination unit 320 may determine an area where images are superimposed, and may determine a capture viewpoint.

For example, the image capture determination unit 320 may extract feature points from each of the images of the captured object, may compare the extracted feature points, and may determine whether the images are superimposed on at least one predetermined area.

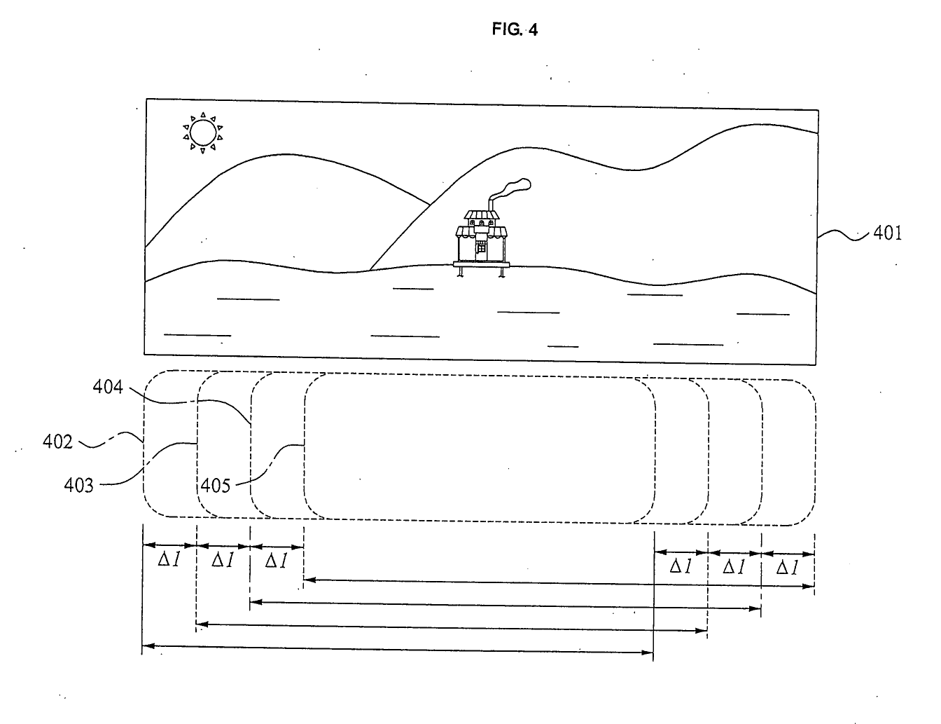

Hereinafter, the capture viewpoints will be further described with reference to FIG. 4.

FIG. 4 illustrates a diagram of capture viewpoints captured from a plurality of viewpoints according to one or more embodiments.

Images may be created from capture viewpoints generated by rotating a camera for each angle ‘θ’. Here, a portion of the created images may be superimposed.

The created images may have only a negligible difference from images acquired by horizontally moving a camera by ‘Δ/’.

First, a camera may capture an image corresponding to a first area 402 of an object 401 from a first capture viewpoint.

Additionally, when the camera is rotated by the angle ‘θ’, the camera may capture an image corresponding to a second area 403 of the object 401 from a second capture viewpoint.

The second area 403 may be interpreted to be shifted from the first area 402 by ‘Δ/’ and accordingly, a difference between the first area 402 and the second area 403 may correspond to twice ‘Δ/’. The first area 402 and the second area 403 may be identical, except for the difference.

The difference between the first area 402 and the second area 403 may be caused by a left image and a right image of a 3D image. The images respectively corresponding to the first area 402 and the second area 403 may be reconstructed into a 3D image.

Accordingly, a first 3D image created by the first area 402 and the second area 403 may be combined with a second 3D image created by a third area 404 and a fourth area 405, to form a portion of a 3D panoramic image.

A greater number of 3D images may be created using images captured from a greater number of capture viewpoints. Accordingly, it is possible to create a 3D panoramic image by combining the greater number of created 3D images.

Referring back to FIG. 3, the image collection unit 330 may collect at least one image of the captured object from the at least one capture viewpoint.

The 3D image creation unit 340 may create a 3D image from the collected at least one image.

Specifically, the 3D image creation unit 340 may classify the collected at least one image into left images and right images, and may create a 3D image.

For example, the image collection unit 330 may collect a first image captured from a first capture viewpoint, and a second image captured from a second capture viewpoint following the first capture viewpoint.

In this example, the 3D image creation unit 340 may respectively determine the first image and the second image as a left image and a right image, and may create a 3D image.

Additionally, to create a 3D panoramic image, the image collection unit 330 may further collect a third image captured from a third capture viewpoint, and a fourth image captured from a fourth capture viewpoint following the third capture viewpoint.

The 3D image creation unit 340 may create a first 3D image using the first image and the second image, may create a second 3D image using the third image and the fourth image, and may create a 3D panoramic image using the created first 3D image and the created second 3D image.

According to one or more embodiments, when the portable terminal device 300 is used, a 3D panoramic image may be created using a single camera based on only location information of an input image, in an existing 2D panorama system.

Additionally, when the portable terminal device 300 is used, there is no need to change a camera system for 3D capturing such as 3D lenses or a stereoscopic system. Accordingly, the portable terminal device 300 may be compatible with an existing system.

Furthermore, when the portable terminal device 300 is used, it is possible to appreciate, in a 3D mode, a panoramic image captured by a camera, in a 3D display apparatus such as a 3D Television (TV).

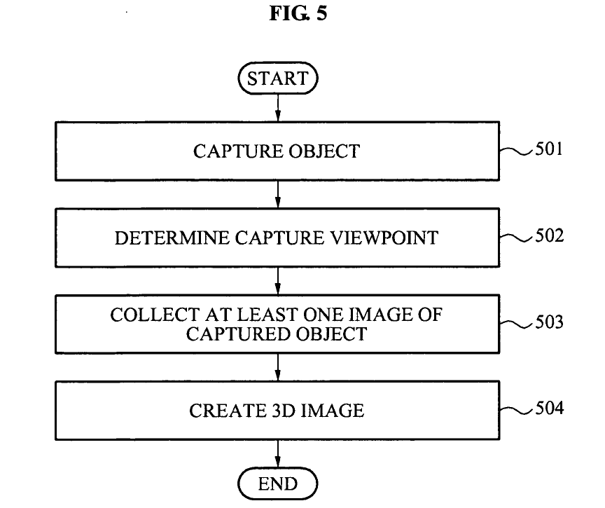

FIG. 5 illustrates a flowchart of a 3D image generation method of a portable terminal device according to one or more embodiments.

In operation 501, an object may be captured from a plurality of viewpoints. The plurality of viewpoints may be classified based on a rotation in a fixed location, and the rotation may be represented as numerical values by a rotation angle.

In operation 502, a capture viewpoint for capturing an image may be determined.

The capture viewpoint may be interpreted as viewpoints with angles where a camera faces toward an object are spaced apart by multiples of a rotation angle ‘θ’, among the plurality of viewpoints. In other words, a viewpoint where the camera is rotated by a multiple of the angle ‘θ’ may be determined as the capture viewpoint.

Specifically, in operation 502, at least one capture viewpoint from which an image is obtained by capturing the object may be determined among the plurality of viewpoints.

To determine the at least one capture viewpoint, consecutive capture viewpoints may be determined so that the images of the object may be superimposed on at least one predetermined area.

In other words, feature points may be extracted from each of the images of the captured object, and the extracted feature points may be compared. Additionally, whether a first image and a second image among the images of the object are superimposed on at least one predetermined area may be determined. Here, the first image may be captured from a first capture viewpoint.

When the first image and the second image are determined to be superimposed, a viewpoint from which the second image is captured may be determined as a second capture viewpoint.

In operation 503, at least one image of the captured object from the at least one capture viewpoint may be collected.

Here, a portion of the at least one image may be classified as left images, and the other portion may be classified as right images. The left images and right images may be used to create a 3D image.

For example, images of an object captured from even-numbered capture viewpoints may be classified as left images, and images of an object captured from odd-numbered capture viewpoints may be classified as right images.

In operation 504, a 3D image may be created from the collected at least one image.

In the 3D image generation method of FIG. 5, it is possible to create a 3D image using a left image captured from a predetermined even-numbered capture viewpoint, and a right image captured from a predetermined odd-numbered capture viewpoint following the predetermined even-numbered capture viewpoint.

Additionally, in the 3D image generation method of FIG. 5, it is possible to create a 3D panoramic image by combining 2D images that are sequentially created by capture viewpoints.

For reference, it is possible to create a left 2D panoramic image using images captured for left images, and to create a right 2D panoramic image using images captured for right images, through the 3D image generation method of FIG. 5.

Generally, a 3D TV may reproduce input 2D images for left eye and right eye into a 3D image. Accordingly, the created left 2D panoramic image and created right 2D panoramic image may be output as a 3D panoramic image in the 3D TV.

Specifically, in the 3D image generation method of FIG. 5, a first image, a second image, a third image, and a fourth image may be collected. Here, the first image, the second image, the third image, and the fourth image may be respectively captured from a first capture viewpoint, a second capture viewpoint, a third capture viewpoint, and a fourth capture viewpoint. The first image and the second image may be respectively determined as a left image and a right image, and a first 3D image may be created. Additionally, the third image and the fourth image may be respectively determined as a left image and a right image, and a second 3D image may be created.

Subsequently, a 3D panoramic image may be created using the created first 3D image and the created second 3D image.

The 3D image generation method of the portable terminal device according to the above-described embodiments may be recorded in non-transitory computer-readable media including computer readable instructions such as a computer program to implement various operations by executing computer readable instructions to control one or more processors, which are part of a general purpose computer, computing device, a computer system, or a network. The media may also have recorded thereon, alone or in combination with the computer readable instructions, data files, data structures, and the like. The computer readable instructions recorded on the media may be those specially designed and constructed for the purposes of the embodiments, or they may be of the kind well-known and available to those having skill in the computer software arts. The computer-readable media may also be embodied in at least one application specific integrated circuit (ASIC) or Field Programmable Gate Array (FPGA), which executes (processes like a processor) computer readable instructions. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of computer readable instructions include both machine code, such as produced by a compiler, and files containing higher level code that may be executed by the computer using an interpreter. The described hardware devices may be configured to act as one or more software modules in order to perform the operations of the above-described embodiments, or vice versa. Another example of media may also be a distributed network, so that the computer readable instructions are stored and executed in a distributed fashion.

According to one or more embodiments, it is possible to create a 3D panoramic image using only a single camera.

Additionally, according to one or more embodiments, existing portable terminal devices may be compatible so as to create a 3D panoramic image without a change in hardware.

Although embodiments have been shown and described, it would be appreciated by those skilled in the art that changes may be made in these embodiments without departing from the principles and spirit of the disclosure, the scope of which is defined in the claims and their equivalents.

What is claimed is:

1. A portable terminal device, comprising:
an image capture determination unit to determine at least one capture viewpoint from which an image is obtained by capturing an object from a plurality of viewpoints;
an image collection unit to collect at least one image of the captured object from the at least one capture viewpoint; and
a three-dimensional (3D) image creation unit to create a 3D image from the collected at least one image using at least one processor.

2. The portable terminal device of claim 1, further comprising a capturing unit which captures the object from the plurality of viewpoints by a rotation in a fixed location.

3. The portable terminal device of claim 2, wherein the at least one capture viewpoint is classified as a rotation angle of a selected size.

4. The portable terminal device of claim 3, wherein the image capture determination unit determines a size of the rotation angle so that images of the object captured from consecutive capture viewpoints are superimposed on at least one predetermined area.

5. The portable terminal device of claim 4, wherein the image capture determination unit extracts feature points from each of the images of the captured object, compares the extracted feature points, and determines whether the images are superimposed on the at least one predetermined area.

6. The portable terminal device of claim 1, wherein the image collection unit collects a first image captured from a first capture viewpoint, and a second image captured from a second capture viewpoint following the first capture viewpoint, and
wherein the 3D image creation unit determines the first image as a left image, determines the second image as a right image, and creates a 3D image.

7. The portable terminal device of claim 6, wherein the image collection unit collects a third image captured from a third capture viewpoint, and a fourth image captured from a fourth capture viewpoint following the third capture viewpoint, and
wherein the 3D image creation unit creates a first 3D image using the first image and the second image, creates a second 3D image using the third image and the fourth image, and creates a 3D panoramic image using the created first 3D image and the created second 3D image.

8. A three-dimensional (3D) image generation method of a portable terminal device, the 3D image generation method comprising:
determining at least one capture viewpoint from which an image is obtained by capturing an object from a plurality of viewpoints;
collecting at least one image of the captured object from the at least one capture viewpoint; and
creating a 3D image from the at least one collected image using at least one processor,
wherein the plurality of viewpoints are classified based on a rotation in a fixed location.

9. The 3D image generation method of claim 8, wherein the determining comprises determining consecutive capture viewpoints so that images of the object are superimposed on at least one predetermined area.

10. The 3D image generation method of claim 8, wherein the determining comprises:
extracting feature points from each of the images of the captured object;
comparing the extracted feature points, and determining whether a first image and a second image among the images of the captured object are superimposed on at least one predetermined area, the first image being captured from a first capture viewpoint; and
determining, as a second capture viewpoint, a viewpoint from which the second image is captured, when the first image and the second image are superimposed on the at least one predetermined area.

11. The 3D image generation method of claim 8, wherein the collecting comprises collecting a first image captured from a first capture viewpoint, a second image captured from a second capture viewpoint, a third image captured from a third capture viewpoint, and a fourth image captured from a fourth capture viewpoint, and
wherein the creating comprises:
determining the first image as a left image, determining the second image as a right image, and creating a first 3D image;
determining the third image as a left image, determining the fourth image as a right image, and creating a second 3D image; and
creating a 3D panoramic image using the created first 3D image and the created second 3D image.

12. At least one non-transitory computer readable recording medium storing computer readable instructions that control at least one processor to implement the method of claim 8.

13. A portable terminal device for generating a three dimensional (3D) image, comprising:
a capturing unit which captures the object from the plurality of viewpoints generated by a rotation in a fixed location;
an image capture determination unit, using at least one processor, to determine at least one capture viewpoint, which is classified as a rotation angle of a selected size, by determining the selected size of the rotation angle so that images of the object captured from consecutive capture viewpoints are superimposed on at least one predetermined area; and
an image collection unit to collect at least one image of the captured object from the at least one capture viewpoint for generation of the 3D image.

14. The portable terminal device of claim 13, wherein the image capture determination unit extracts feature points from each of the images of the captured object, compares the extracted feature points, and determines whether the images are superimposed on the at least one predetermined area.

15. The portable terminal device of claim 13, wherein:
the portable terminal device further comprises a three-dimensional (3D) image creation unit to create the 3D image from the collected at least one image;
the image collection unit collects a first image captured from a first capture viewpoint, and a second image captured from a second capture viewpoint following the first capture viewpoint, and
the 3D image creation unit determines the first image as a left image, determines the second image as a right image, and creates a 3D image.
